(19) United States
(12) Patent Application Publication
(10) Pub. No.: US 2025/0260432 A1
(43) Pub. Date: Aug. 14, 2025

(54) ELECTRONIC CONTROLLER

(71) Applicant: DENSO CORPORATION, Kariya-City (JP)

(72) Inventors: Ryuji YANAGISAWA, Kariya-city (JP); Mitsuru NAKAMURA, Kariya-city (JP)

(21) Appl. No.: 19/047,283

(22) Filed: Feb. 6, 2025

(30) Foreign Application Priority Data
Feb. 9, 2024 (JP) 2024-018693

(51) Int. Cl. H04B 1/16; B60L 3/00

(52) U.S. Cl. CPC H04B 1/1615; B60L 3/0046; B60L 3/0084

(57) ABSTRACT

OBJECT To provide an electronic controller capable of achieving reprogramming even when a power supply switch is turned off.

SOLVING MEANS

An electronic control device 20 includes an in-device power supply 22, a multi-function power supply 26, and the controller 50. The in-device power supply 22 is supplied with electrical power from a battery 10 and works to deliver electrical power or stop such delivery in response to turning on or off of a power supply switch 12. The multi-function power supply 26 receives a supply of electrical power from the in-device power supply 22 in response to turning on of the power supply switch 12. The controller 50 is supplied with electrical power from the multi-function power supply 26 and perform a reprogramming task. The multi-function power supply works to keep the in-device power supply delivering electrical power to the multi-function power supply in response to the power supply switch being turned on, thereby enabling the in-device power supply to continue to deliver electrical power to the controller through the multi-function power supply when the power supply switch is changed from an on-state to an off-state, and the controller is required to perform the reprogramming task.

### CROSS REFERENCE TO RELATED DOCUMENT

The present application claims the benefit of priority of Japanese Patent Application No. 2024-18693 filed on Feb. 9, 2024, the disclosure of which is incorporated in its entirety herein by reference.

### BACKGROUND

### Technical Field

This disclosure relates generally to an electronic controller.

### Background Art

International application No. WO 2014/045785 A1 teaches a control system for electrical vehicles which includes a power supply, a first microcomputer, and a second microcomputer. The first and second microcomputers share the power supply with each other, are equipped with control features different from each other, and have control programs rewritable independently from each other.

When it is required to perform a reprogramming task to revise the program in the above type of control system, a power supply switch which is used to deliver electrical power from a power supply or stop such power delivery may be turned off. When the power supply switch is turned off, it will cause no power to be delivered from the power supply both to the first microcomputer and to the second microcomputer, which makes it impossible to perform the reprogramming task.

### SUMMARY

It is an object of this disclosure to provide an electronic controller which is capable of performing a reprogramming task even after a power supply switch is turned off.

According to one aspect of this disclosure, there is provided an electronic controller which comprises: (a) a first power supply which is supplied with electrical power from a power source and works to achieve or stop supply of electrical power in response to on- or off-operation of a power supply switch; (b) a multi-function power supply to which electrical power is delivered from the first power supply when the power supply switch is turned on; and (c) a controller to which electrical power is delivered from the multi-function power supply and which works to perform a reprogramming task. The multi-function power supply works to keep the first power supply delivering electrical power to the multi-function power supply in response to the power supply switch being turned on, thereby enabling the first power supply to continue to deliver electrical power to the controller through the multi-function power supply when the power supply switch is changed from an on-state to an off-state, and the controller is required to perform the reprogramming task.

The above structure works to continue to deliver electrical power to the controller even when the power supply switch is turned off, thereby enabling the reprograming task to be performed.

Reference marks or numbers in parentheses are attached to elements described in this application. Such reference marks or numbers merely represent an example of a correspondence relation between the elements and parts in the following embodiments. This disclosure is, therefore, not limited to the embodiments by use of the reference marks or numbers.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a structural view which illustrates a system in which an electronic control device is used according to an embodiment; and

FIG. 2 is a flowchart of a task performed by a controller installed in an electronic control device according to an embodiment.

### DESCRIPTION OF THE PREFERRED EMBODIMENT

The electronic control device 20 (which will also referred to herein as an electronic controller) according to the embodiment will be described below with reference to the drawings in which same reference numbers refer to the same parts or equivalents thereof, and explanation thereof in detail will be omitted.

The electronic control device 20 is used with, for example, a system which is installed in a vehicle and capable of performing reprograming for the electronic control device 20 even when the power supply switch 12 is turned off. Such a system will first be described below.

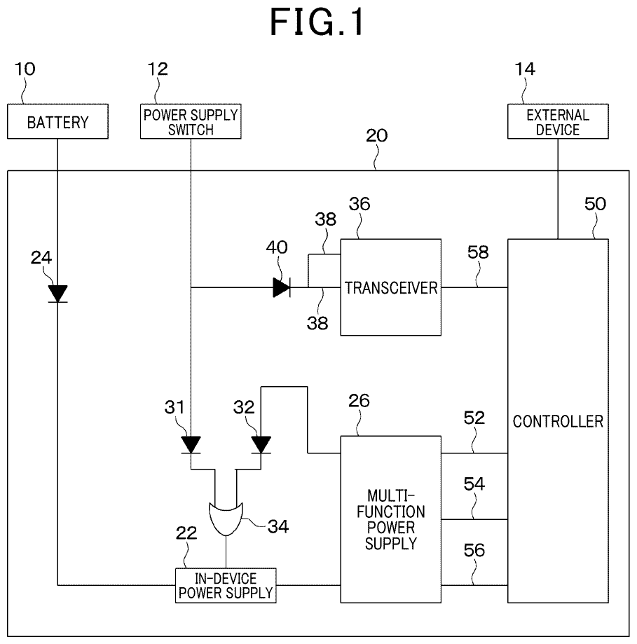

The system, as illustrated in FIG. 1, includes the battery 10, the power supply switch 12, the external device 14, and the electronic control device 20.

The battery 10 functions as a power supply in this embodiment and is disposed outside the electronic control device 20 (which will be described later in detail). The battery 10 is electrically connected to the electronic control device 20 to deliver electrical power to the electronic control device 20.

The power supply switch 12 is implemented by, for example, an ignition switch of the vehicle. The power supply switch 12 is arranged outside the electronic control device 20 and connected to the electronic control device 20. When the power supply switch 12 is turned on, it outputs a signal whose level of voltage is high to the electronic control device 20. Alternatively, when the power supply switch 12 is turned off, it outputs a signal whose level of voltage is low to the electronic control device 20.

The external device 14 is equipped with a computer and a communication interface and located outside the electronic control device 20. The external device 14 is connected to the electronic control device 20. The external device 14 instructs the electronic control device 20 to perform a reprogramming task.

The electronic control device 20 includes the in-device power supply 22 (which will also be referred to as a first power supply), the power supply-side diode 24, the multi-function power supply 26, the first diode 31, the second diode 32, the OR circuit 34, the transceiver 36, the parallel wires 38, and the transceiver-side diode 40. The electronic control device 20 also includes the controller 50, the power supply-side communication line 52, the reset signal line 54, the power line 56, and the transceiver-side communication line 58.

The in-device power supply 22 includes a DC-to-DC converter and a regulator. The in-device power supply 22 is connected to a cathode of the power supply-side diode 24. The power supply-side diode 24 is connected at an anode thereof to the battery 10. The electrical power is, therefore, supplied from the battery 10 to the in-device power supply 22 through the power supply-side diode 24.

The multi-function power supply 26 (which will also be referred to as a second power supply) is made of a PMIC (Power Management Integrated Circuit). The multi-function power supply 26 is supplied with electrical power from the in-device power supply 22.

The first diode 31 is connected at an anode thereof to the power supply switch 12. The second diode 32 is connected at an anode thereof to the multi-function power supply 26.

The OR circuit 34 is connected to a cathode of the first diode 31, a cathode of the second diode 32, and the in-device power supply 22. The OR circuit 34 works to logically OR the signals from the power supply switch 12 and the multi-function power supply 26. The OR circuit 34, therefore, produces a signal that is high in voltage when an output from the power supply switch 12 or the multi-function power supply 26 is at a high level of voltage and outputs it (i.e., high-level signal) to the in-device power supply 22. The OR circuit 34 outputs a low-level signal to the in-device power supply 22 when the low-level signals are inputted both from the power supply switch 12 and from the multi-function power supply 26.

The transceiver 36 is equipped with an A/D converter. The transceiver 36 is connected to the parallel wires 38. The parallel wires 38 are made of two discrete conductors extending parallel to each other and connected to the cathode of the transceiver-side diode 40. The anode of the transceiver-side diode 40 is connected to the power supply switch 12. The transceiver 36, therefore, receives an on- or off-signal through the transceiver-side diode 40 and the parallel wires 38 in response to turning on or off of the power supply switch 12. In other words, the transceiver 36 monitors an on- or off-state of the power supply switch 12. The transceiver 36 outputs an on- or off-signal to the controller 50 in response to the on- or off-signal from the power supply switch 12.

The controller 50 is mainly made of a microcomputer which includes a CPU, a ROM, a flash memory, a RAM, an I/O unit, and bus lines connecting them. The controller 50 is connected to first ends of the power supply-side communication line 52, the reset signal line 54, and the power line 56. The power supply-side communication line 52, the reset signal line 54, and the power line 56 are connected at second ends thereof to the multi-function power supply 26.

The controller 50 communicates with the multi-function power supply 26 through the power supply-side communication line 52 using, for example, an I2C (i.e., Inter-Integrated Circuit). The I2C is one of synchronous serial communication interfaces through which data is transmitted in synchronous with clocks.

The controller 50 receives a reset signal, as will be described later in detail, which is outputted from the multi-function power supply 26 through the reset signal line 54. The controller 50 is also supplied with electrical power from the multi-function power supply 26 through the power line 56.

The controller 50 connects with a first end of the transceiver-side communication line 58. The transceiver-side communication line 58 is connected at a second end thereof to the transceiver 36. The controller 50 communicates with the transceiver 36 through the transceiver-side communication line 58 using, for example, a SPI (i.e., Serial Peripheral Interface) which is one of synchronous serial communication interfaces through which data is transmitted in synchronous with clocks. The SPI is higher in communication rate than the I2C.

When the power supply switch 12 is switched from an off-state to an on-state, it causes the level of voltage of an output from the power supply switch 12 to be changed from a low level to a high level. The power supply switch 12, therefore, output the high-level signal to the OR circuit 34. The OR circuit 34 then outputs a high-level signal to the in-device power supply 22. The in-device power supply 22 supplies electrical power to the multi-function power supply 26. The multi-function power supply 26 delivers electrical power to the controller 50 through the power line 56.

The controller 50, then, starts executing a program stored in the ROM installed therein to determine whether the transceiver 36 is malfunctioning using the signal outputted from the transceiver 36. The controller 50 also controls the operation of the multi-function power supply 26 in order to enable the reprogramming task to be performed even after the power supply switch 12 is turned off. How to determine whether the transceiver 36 is malfunctioning and how to control the operation of the multi-function power supply 26 will be described later in detail.

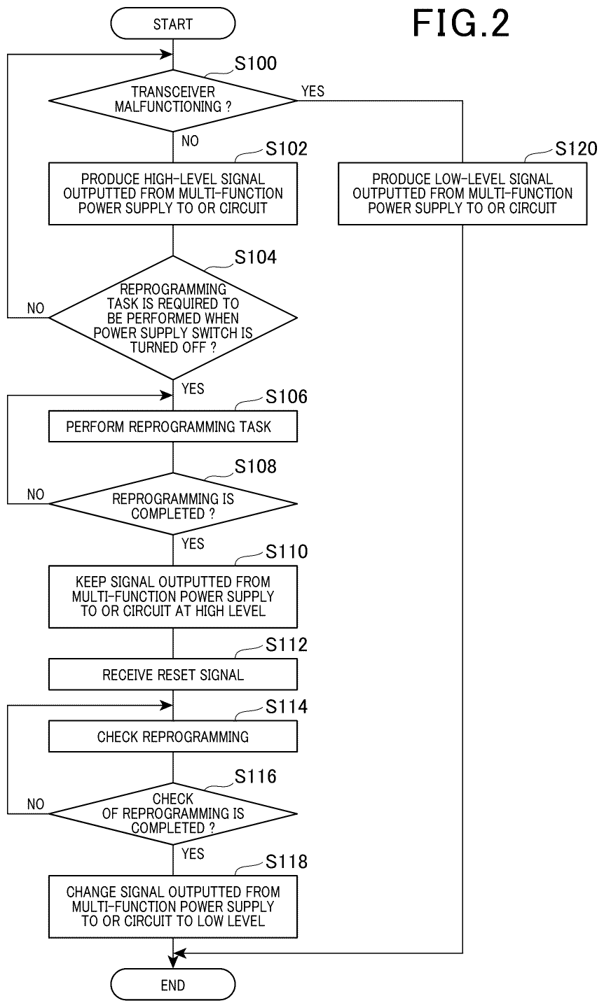

The system using the electronic control device 20 is designed to have the above-described structure. How to determine whether the transceiver 36 is malfunctioning and how to control the operation of the multi-function power supply 26 by executing the program in the controller 50 will be described below with reference to FIG. 2.

After entering the program in FIG. 2 in the controller 50, the routine proceeds to step S100 wherein it is determined whether the transceiver 36 is malfunctioning. In other words, the controller 50 determines whether the transceiver 36 is properly monitoring the on- or off-operation of the power supply switch 12.

Specifically, the controller 50 obtains two signals (which will referred to below as a first signal and a second signal) which arise from an output of the power supply switch 12 and are received by the transceiver 36 through the parallel wires 38. When the transceiver 36 is properly operating, it will cause the first and second signals to be the same, in other words, an absolute value of a difference in level between the first and second signals to be low. Accordingly, when such an absolute value is lower than a predetermined threshold value, the controller 50 determines that the transceiver 36 is properly operating. The predetermined threshold value is set by means of experiments or simulations performed to ensure the determination of malfunction of the transceiver 36.

The controller 50 may alternatively communicate with the transceiver 36 and determine whether the transceiver 36 is malfunctioning using a CRC (i.e., Cyclic Redundancy Check) instead of the above way.

The voltage at the transceiver 36 when the transceiver 36 is properly operating may be defined as a reference voltage. The controller may determine whether the transceiver 36 is malfunctioning based on comparison between the voltage at the transceiver 36 and the reference voltage instead of the above way of the determination of malfunction. Specifically, the controller 50 obtains the voltage appearing within the transceiver 36 from the transceiver 36. When an absolute value of a difference between the obtained voltage in the transceiver 36 and the reference voltage is lower than a reference threshold value, the controller 50 determines that the transceiver 36 is properly operating. Alternatively, when the above absolute value is higher than or equal to the reference threshold value, the controller 50 determines that the transceiver 36 is malfunctioning. The reference threshold value may be set by means of experiments or simulations performed to ensure the determination of malfunction of the transceiver 36.

If a YES answer is obtained in step S100, meaning that the transceiver 36 is malfunctioning, in other words, the transceiver 36 is not properly monitoring the on- or off-state of the power supply switch 12, then the routine proceeds to step S120. Alternatively, if a NO answer is obtained, meaning that the transceiver 36 is properly operating, in other words, the transceiver 36 is properly monitoring the on- or off-state of the power supply switch 12, then the routine proceeds to step S102.

After step S100, the routine proceeds to step S102 wherein the controller 50 outputs a control signal to the multi-function power supply 26 to instruct the multi-function power supply 26 to output the high-level signal to the OR circuit 34 in order to enable the reprogramming task to be performed even after the power supply switch 12 is turned off. The multi-function power supply 26 is responsive to the input of the control signal to produce and transmit the high-level signal to the OR circuit 34. This causes the OR circuit 34 to output the high-level signal to the in-device power supply 22 regardless of the voltage level of the on- or off-signal outputted from the power supply switch 12. The in-device power supply 22 is responsive to the high-level signal to continue to deliver electrical power to the multi-function power supply 26 even when the power supply switch 12 is turned off. The multi-function power supply 26 also delivers electrical power to the controller 50 through the power line 56 even when the power supply switch 12 is turned off. This enables the controller 50 to continue to operate properly to perform the reprograming task.

After step S102, the routine proceeds to step S104 wherein it is determined whether the controller 50 is required to perform the reprogramming task when the power supply switch 12 is in the off-state.

Specifically, the controller 50 obtains from the transceiver 36 the voltage level of a signal outputted from the power supply switch 12. When the signal outputted from the power supply switch 12 is at the low voltage level, the controller 50 concludes that the power supply switch 12 is in the off-state. Alternatively, when the signal outputted from the power supply switch 12 is at the high voltage level, the controller 50 concludes that the power supply switch 12 is in the on-state.

Further, when receiving a reprogramming instruction signal from the external device 14, the controller 50 determines that the reprogramming task should be started. Alternatively, when receiving no reprograming instruction signal from the external device 14, the controller 50 determines that the reprogramming task is required not to be performed.

If a NO answer is obtained in step S104, meaning that the power supply switch 12 is turned on or that the reprogramming task is required not to be performed, the routine returns back to step S100. Alternatively, if the power supply switch 12 is turned off, and the reprogramming task is required to be performed, then the routine proceeds to step S106.

In step S106, the controller 50 starts performing the reprogramming task in response to a signal outputted from the external device 14.

When the controller 50 has started to be reprogrammed, the multi-function power supply 26 communicates with the controller 50 and determines whether the controller 50 is malfunctioning.

Specifically, the multi-function power supply 26 uses, for example, a watchdog timer to determine whether the controller 50 is failing in operation.

Instead of the above diagnostic manner, the multi-function power supply 26 may diagnose the controller 50 in the following way. The multi-function power supply 26 calculates a first parameter used to diagnose the failure in operation of the controller 50. Similarly, the controller 50 calculates a second parameter used to diagnose the failure in operation of the controller 50. The multi-function power supply 26 determines whether the first parameter calculated by the multi-function power supply 26 and the second parameter calculated by the controller 50 are matched with each other to diagnose whether the controller 50 is failing in operation. When the first parameter is identical with the second parameter, the multi-function power supply 26 determines that the controller 50 is operating properly. Alternatively, when the first parameter is different from the second parameter, the multi-function power supply 26 determines that the controller 50 is failing in operation.

Instead of the above diagnostic manner, the multi-function power supply 26 may alternatively determine whether the multi-function power supply 26 has properly received a signal from the controller 50 to diagnose the controller 50. Specifically, when having received a signal from the controller 50, the multi-function power supply 26 determines whether the controller 50 is properly operating. Alternatively, when receiving no signal from the controller 50, the multi-function power supply 26 determines whether the controller 50 is failing in operation.

When the controller 50 is malfunctioning, it means that it is impossible for the controller 50 to properly perform the reprogramming task. The multi-function power supply 26, therefore, changes the voltage level of a signal to be outputted to the OR circuit 34 to the low level. The multi-function power supply 26 then outputs such a low-level signal to the OR circuit 34. In this case, the signal outputted from the power supply switch 12 is at the low voltage level, and the signal from the multi-function power supply 26 is at the low-voltage level. The OR circuit 34, therefore, outputs the low-level signal to the in-device power supply 22. The in-device power supply 22 then stops delivering electrical power to the multi-function power supply 26. Additionally, the multi-function power supply 26 stops delivering electrical power to the controller 50. This minimizes waste or unnecessary consumption of electrical energy consumed in the electronic control device 20 when it is impossible to properly reprogram the controller 50. Alternatively, when the controller 50 is properly operating, the multi-function power supply 26 keeps a signal outputted therefrom to the OR circuit 34 at the high voltage level.

After step S106, the routine proceeds to step S108 wherein the controller 50 determines whether the reprogramming performed in step S106 is completed. If a NO answer is obtained, meaning that the reprogramming is not yet completed, then the routine returns back to step S106 to continue to perform the reprogramming task. Alternatively, if a YES answer is obtained, meaning that the reprogramming is completed, then the routine proceeds to step S110.

When the reprogramming is completed, it leads to a risk that the multi-function power supply 26 may output a reset signal using a reset signal line to initialize the controller 50, thus causing a signal transmitted from the controller 50 to the multi-function power supply 26 to be initialized. Such initialization will cause the signal outputted from the multi-function power supply 26 to the OR circuit 34 to be changed from the high level to the low level (i.e., an initial voltage level). In this case, the signal outputted from the power supply switch 12 is at the low level, and the signal outputted from the multi-function power supply 26 is at the low level. The OR circuit 34, therefore, outputs the low-level signal to the in-device power supply 22. The in-device power supply 22 then stops delivering electrical power to the multi-function power supply 26. The multi-function power supply 26 also stops delivering electrical power to the controller 50. This will cause the controller 50 to be unable to check the reprogramming even though the reprogramming is completed.

Consequently, after step S108, the routine proceeds to step S110 wherein the controller 50 outputs a signal to the multi-function power supply 26 to instruct the multi-function power supply 26 to keep a signal transmitted to the OR circuit 34 at the high voltage level.

The routine proceeds to step S112 wherein the controller 50 receives a reset signal from the multi-function power supply 26 through the reset signal line 54, so that the controller 50 is initialized. The multi-function power supply 26 keeps a signal outputted to the OR circuit 34 at the high voltage level in response to the signal transmitted from the controller 50, as described in step S110. This causes the in-device power supply 22 to continue to deliver electrical power to the multi-function power supply 26. The multi-function power supply 26 also continues to supply electrical power to the controller 50.

The routine then proceeds to step S114 wherein the controller 50 checks the reprogramming performed in step S106.

The routine proceeds to step S116 wherein it is determined whether the check of the reprogramming performed in in step S114 is completed. If a NO answer is obtained, meaning that the check of the reprogramming is not yet completed, then the routine returns back to step S114. Alternatively, if a YES answer is obtained, meaning that the check of the reprogramming is completed, then the routine proceeds to step S118.

In step S118, as entered when the reprogramming and the check or verification thereof are completed, the controller 50 outputs a signal to the multi-function power supply 26 to instruct the multi-function power supply 26 to change the signal outputted to the OR circuit 34 to the low voltage level in order to complete the task in the controller 50.

The multi-function power supply 26 then sets the signal transmitted therefrom to the OR circuit 34 to the voltage low level and outputs it to the OR circuit 34. The signal outputted from the power supply switch 12 is at the low voltage level. Similarly, the signal outputted from the multi-function power supply 26 is also at the low voltage level. This causes the OR circuit 34 to output the low-level signal to the in-device power supply 22, so that the in-device power supply 22 stops delivering electrical power to the multi-function power supply 26. Additionally, the multi-function power supply 26 also stops delivering electrical power to the controller 50, so that the controller 50 stops or completes the task.

If a YES answer is obtained in step S100, meaning that the transceiver 36 is malfunctioning, it is impossible for the transceiver 36 to properly monitor the on- or off-operation of the power supply switch 12, thereby leading to a high possibility that the task performed by the controller 50 to achieve communication with the transceiver 36 may be improper, which results in a waste of electrical power supplied to the controller 50.

Therefore, in step S120, the controller 50 outputs a signal to the multi-function power supply 26 to instruct the multi-function power supply 26 to change the level of a signal outputted to the OR circuit 34 to the low voltage level. The routine then terminates.

The multi-function power supply 26 then transmits the low-level signal to the OR circuit 34. The signal outputted from the multi-function power supply 26 is at the low voltage level, but the power supply switch 12 is turned on, so that the signal outputted by the power supply switch 12 is at the high voltage level. This causes the OR circuit 34 to output the high-level signal to the in-device power supply 22.

Afterwards, when turned off, the power supply switch 12 outputs the low-level signal. The signal outputted from the multi-function power supply 26 is, therefore, changed to the low voltage level. Accordingly, when the power supply switch 12 is turned off, the OR circuit 34 outputs the low-level signal to the in-device power supply 22, so that the in-device power supply 22 stops delivering electrical power to the multi-function power supply 26. Additionally, the multi-function power supply 26 also stops delivering electrical power to the controller 50. In other words, when the power supply switch 12 is changed from the on-state to the off-state when the transceiver 36 is malfunctioning, the multi-function power supply 26 stops the delivery of electrical power thereto from the in-device power supply 22. This minimizes the unnecessary consumption of electrical power consumed in the electronic control device 20 when it is impossible to properly perform the task in the transceiver 36 or the controller 50.

The controller 50 works to perform the task in the above-described way. The operation of the electronic control device 20 to enable the reprogramming task to be performed even when the power supply switch 12 is turned off will be described below in detail.

The electronic control device 20, as described already, includes the in-device power supply 22, the multi-function power supply 26, and the controller 50. The in-device power supply 22 is supplied with electrical power from the battery 10 and works to achieve or stop supply of electrical power in response to the on- or off-operation of the power supply switch 12. When the power supply switch 12 is turned on, the multi-function power supply 26 receives a supply of electrical power from the in-device power supply 22. The controller 50 is supplied with electrical power from the multi-function power supply 26 and perform the reprogramming task. The multi-function power supply 26 is responsive to the signal, as generated by the controller 50 in step S102 when the power supply switch 12 is turned on, to keep the in-device power supply 22 delivering electrical power to the multi-function power supply 26. This enables the in-device power supply 22 to continue to deliver electrical power to the controller 50 through the multi-function power supply 26 and the power line 56, as discussed in steps S104 to S106, when and after the power supply switch 12 is switched from the on-state to the off-state, and the controller 50 starts to be reprogrammed

The electrical power, therefore, continues to be delivered to the controller 50 after the power supply switch 12 is turned off, thereby enabling the controller 50 to be reprogrammed.

The above-described structure of the electronic control device 20 in this embodiment offers the following beneficial advantages.

1) The multi-function power supply 26 is responsive to the signal, as produced by the controller 50 in step S110, to continue the supply of electrical power from the in-device power supply 22 to the controller 50 when the reprogramming task is being completed. In other words, the multi-function power supply 26 works to continue to deliver the electrical power to the controller 50 at least until the controller 50 completes the reprogramming task.

The above operation causes the supply of electrical power to the controller 50 to continue even when the controller 50 receives the reset signal which performs the initialization of the controller 50. This enables the verification of the reprogramming to be achieved properly after the controller 50 is reprogrammed even when the controller 50 receives the reset signal.

2) When it is required to reprogram the controller 50, the multi-function power supply 26 communicates with the controller 50 to determine whether the controller 50 is malfunctioning. When the controller 50 is determined to be malfunctioning, the multi-function power supply 26 stops the in-device power supply 22 from delivering the electrical power to the controller 22.

The above operation minimizes waste of electrical power consumed in the electronic control device 20 when the controller 50 fails in performing the reprogramming task and also alleviates a risk that the battery 10 which serves to deliver electrical power to the in-device power supply 22 may run out.

3) The controller 50, as described in step S100, analyzes the signal outputted from the transceiver 36 to diagnose the operation of the transceiver 36. When the transceiver 36 is determined to be malfunctioning, the multi-function power supply 26 is responsive to the signal, as produced by the controller 50 in step S120, to stop the supply of electrical power from the in-device power supply 22 when the power supply switch 12 is changed from the on-state to the off-state.

The above operation minimizes waste of electrical power consumed in the electronic control device 20 when the transceiver 36 or the controller 50 fails in operation thereof and also alleviates a risk that the battery 10 which serves to deliver electrical power to the in-device power supply 22 may be exhausted.

### Other Embodiments

This disclosure is not limited to the above embodiments, but may be realized by various embodiments without departing from the purpose of the disclosure. This disclosure includes all possible combinations of the features of the above embodiments or features similar to the parts of the above embodiments. The structures in this disclosure may include only one or some of the features discussed in the above embodiments unless otherwise inconsistent with the aspects of this disclosure.

The controller or how to construct it referred to in this disclosure may be realized by a special purpose computer which is equipped with a processor and a memory and programmed to execute one or a plurality of tasks created by computer-executed programs or alternatively established by a special purpose computer equipped with a processor including one or a plurality of hardware logical circuits. The controllers or operations thereof referred to in this disclosure may alternatively be realized by a combination of an assembly of a processor with a memory which is programmed to perform one or a plurality of tasks and a processor made of one or a plurality of hardware logical circuits. Computer-executed programs may be stored as computer executed instructions in a non-transitory computer readable medium.

A power source which delivers electrical energy to the in-device power supply 22 is the battery 10 in the above embodiment, but however, may alternatively be implemented by another source, such as a grid-scale battery.

The power supply switch 12 is provided by an ignition switch installed in the vehicle in the above embodiment, but however, may alternatively be implemented by another switch for use in delivering electrical power within the electronic control device 20.

The above embodiments realize the following unique structures.

### First Structure

An electronic controller comprises: (a) a first power supply (22) which is supplied with electrical power from a power source (10) and works to achieve or stop supply of electrical power in response to on- or off-operation of a power supply switch (12); (b) a multi-function power supply (26) to which electrical power is delivered from the first power supply when the power supply switch is turned on; and (c) a controller (50) to which electrical power is delivered from the multi-function power supply and which works to perform a reprogramming task. The multi-function power supply works to keep the first power supply delivering electrical power to the multi-function power supply in response to the power supply switch being turned on, thereby enabling the first power supply to continue to deliver electrical power to the controller through the multi-function power supply when the power supply switch is changed from an on-state to an off-state, and the controller is required to perform the reprogramming task.

### Second Structure

The electronic controller as set forth in the first structure, wherein when the reprogramming task is completed in the controller, the multi-function power supply keeps the first power supply delivering electrical power thereto.

### Third Structure

The electronic controller as set forth in the first structure, wherein when the controller is required to perform the reprogramming task, the multi-function power supply communicates with the controller to determine whether the controller is malfunctioning. When it is determined that the controller is malfunctioning, the multi-function power supply stops the first power supply from delivering electrical power to the multi-function power supply.

### Fourth Structure

The electronic controller as set forth in any one of the first to third structures, further comprises a transceiver (36) which receives an on-signal or an off-signal from the power supply switch and outputs a signal indicative thereof to the controller. The controller analyzes the signal from the transceiver to determine whether the transceiver is malfunctioning. When the transceiver is determined to be malfunctioning, and the power supply switch is changed from the on-state to the off-state, the multi-function power supply stops the first power supply from delivering electrical power to the multi-function power supply.

What is claimed is:

1. An electronic controller comprising:
a first power supply which is supplied with electrical power from a power source and works to achieve or stop supply of electrical power in response to on- or off-operation of a power supply switch;
a multi-function power supply to which electrical power is delivered from the first power supply when the power supply switch is turned on; and
a controller to which electrical power is delivered from the multi-function power supply and which works to perform a reprogramming task, wherein
the multi-function power supply works to keep the first power supply delivering electrical power to the multi-function power supply in response to the power supply switch being turned on, thereby enabling the first power supply to continue to deliver electrical power to the controller through the multi-function power supply when the power supply switch is changed from an on-state to an off-state, and the controller is required to perform the reprogramming task.

2. The electronic controller as set forth in claim 1, wherein when the reprogramming task is completed in the controller, the multi-function power supply keeps the first power supply delivering electrical power thereto.

3. The electronic controller as set forth in claim 1, wherein when the controller is required to perform the reprogramming task, the multi-function power supply communicates with the controller to determine whether the controller is malfunctioning, and
when it is determined that the controller is malfunctioning, the multi-function power supply stops the first power supply from delivering electrical power to the multi-function power supply.

4. The electronic controller as set forth in claim 1, further comprising a transceiver which receives an on-signal or an off-signal from the power supply switch and outputs a signal indicative thereof to the controller, wherein
the controller analyzes the signal from the transceiver to determine whether the transceiver is malfunctioning,
when the transceiver is determined to be malfunctioning, and the power supply switch is changed from the on-state to the off-state, the multi-function power supply stops the first power supply from delivering electrical power to the multi-function power supply.
